(19) United States
(12) Patent Application Publication
(10) Pub. No.: US 2005/0084831 A1
(43) Pub. Date: Apr. 21, 2005

(54) Training simulator and method of constructing same

(76) Inventors: Robert Peter Ison, Partridge Green (GB); Christopher Bernard Conlon, Eastbourne (GB); Douglas Brian Howell, Brighton (GB); David Philip Allen, Haywards Heath (GB); Mark Robert Reeve-Fowkes, Eastbourne (GB); Laurence Charles Norman, Hastings (GB); Stephen Paul Taylor, Hurstpierpoint (GB)

Correspondence Address: KATTEN MUCHIN ZAVIS ROSENMAN, 525 WEST MONROE STREET, CHICAGO, IL, 60661-3693, US

(21) Appl. No.: 10/687,136

(22) Filed: Oct. 17, 2003

(51) Int. Cl. G09B 19/00; G09B 25/00

(52) U.S. Cl. 434/219; 434/118

(57) ABSTRACT

A training system uses a mechanical mock-up with electrically conductive probe points connected to electronically readable memories, and a simulated diagnostic tool to interface with a system or machine simulation for the purpose of operation, maintenance or procedure training. When a probe of a simulated diagnostic tool comes into contact with a probe point of the mechanical mock-up, the electronically readable memory supplies a unique identifier code that is communicated by the simulated diagnostic tool to the simulation to indicate the contact of the probe with the corresponding probe point. Complex wiring connections between the mechanical mock-up and a computer that runs the simulation are eliminated and construction of the training system is significantly simplified.

### CROSS-REFERENCE TO RELATED APPLICATIONS

This is the first application filed for the present invention.

### MICROFICHE APPENDIX

Not Applicable.

### TECHNICAL FIELD

The invention relates generally to operation, maintenance and procedure training and, in particular, to a maintenance and procedure training system that includes a simulated mechanical mock-up and a simulated diagnostic tool for use with the training system.

### BACKGROUND OF THE INVENTION

There is a wide range of industrial and military applications that require maintenance and procedure training. Training personnel for equipment operation and maintenance requires familiarity with the equipment, familiarity with a plurality of procedures, and familiarity with conditions under which each specific procedure is to be applied, etc. In some instances trainees can be trained using real equipment in an actual working environment. However, in other instances the expense of the equipment; and/or the potential risk or danger to the trainee, trainers, bystanders, the equipment itself, or an environment in which the equipment is operated, is too significant to permit use of the real equipment for training purposes. In such situations, it is preferable to use simulated equipment, which is more economically and safely employed in the training exercises.

Training related to many maintenance, operation and troubleshooting procedures requires learning how to operate test equipment to measure and analyze diagnostic equipment response to inputs gathered using probe sensors. The probe sensors may be used to measure electrical characteristics, temperature, pressure or chemical properties of a system or machine to which the training is related. It is imperative that trainees learn the correct operation of diagnostic equipment connected to the probe sensor, the system or machine, and how to test the system or machine using the diagnostic equipment.

Training systems for procedure training for electrical systems of a variety of different complex machines have been developed. Generally, a part of the electrical system is simulated using a mechanical mock-up (electrical control panels of the complex machine, for example) hard-wired to a computer simulation that is programmed to simulate all functions and reactions of the electrical system required for the training. The mechanical mock-up in conjunction with the computer simulation permits a realistic training exercise that prepares trainees to operate and/or maintain the electrical system of the complex machine.

The most common architecture for such mechanical mock-up uses programmable interface electronics (PIE) input-output (I/O) boards for interfacing with a host computer that runs the computer simulation. Each contact point on the mechanical mock-up is connected to the other contact points, as required, to faithfully represent the system response. When two probes of a simulated digital multimeter (DMM) contact respective contact points, a current passes through a given circuit. This current is communicated to a corresponding part of a PIE I/O board.

There are now training devices that require thousands of probe points representing different components of large interconnected systems. Because of their complexity, such devices are very costly to construct, program and maintain. A large part of the expense is incurred by the requirement for interconnecting the respective probe points with the corresponding PIE I/O boards. As well, a large number of PIE I/O boards, and a significant amount of wiring are also required. The assembly therefore requires highly skilled, experienced personnel.

Since equipment changes in appearance, function and operation with each subsequent model, each manufacturer, etc., it is desirable to have training devices that are adaptable to simulate different configurations and behaviors of a complex system or machine.

There therefore remains a need for a training system that is simple and inexpensive to construct, as well as being easily reconfigurable.

### SUMMARY OF THE INVENTION

It is therefore an object of the invention to provide a training system that is simple and inexpensive to construct.

It is a further object of the invention to provide a training system that is readily reconfigurable to adapt to changes in configuration or function of a simulated system or machine.

The invention therefore provides a system for enabling operation, diagnostic, procedure and maintenance training, comprising a mechanical mock-up of at least a part of a system on which the training is required, the mechanical mock-up having a plurality of probe points which are respectively connected to electronically readable memories that respectively store a unique identifier code. The system includes a host computer comprising means for communicating with a system/machine simulation, and means for associating each unique identifier code with a corresponding probe event. The host computer passes the probe event to the system/machine simulation, and determines a response of the system/machine simulation to the probe event. The training system also comprises a simulated diagnostic tool having at least one probe that can be maneuvered to contact any one of the probe points, means for reading the unique identifier code when one of the probe points is contacted by the probe, means for communicating with the host computer in order to pass each unique identifier code to the host computer and to receive feedback from the host computer, and means for processing the feedback to determine a display value to be displayed.

The invention further provides a simulated diagnostic tool for operation, diagnostic, procedure and maintenance training for a system or machine using a mechanical mock-up that simulates at least a part of the system or machine. The simulated diagnostic tool comprises a probe for supplying an electrical current to an electronically readable memory that is in electrical connection with an electrically conductive probe point of the mechanical mock-up when the probe contacts the probe point; a communications processor communicatively coupled to the simulation, for relaying to the simulation a unique identifier code retrieved by the probe from the electronically readable memory, and for receiving display change data from the simulation; and a display for displaying a value determined using the display change data.

The invention further provides a mechanical mock-up used for training, the mechanical mock-up having a plurality of discrete probe points that may be respectively contacted by a probe of a diagnostic tool used in the training. The mechanical mock-up comprises an electronically readable memory in electrical connection with each probe point, the electronically readable memory storing a unique identifier code that can be read by the diagnostic tool when the probe contacts the probe point.

The invention also provides a method of constructing a training system for at least one of diagnostic, procedure and maintenance training for a system or a machine, comprising constructing a mechanical mock-up of at least a part of the system or the machine, the mechanical mock-up comprising probe points in respective electrical connection with corresponding electronically readable memories that store unique identifier codes; and constructing a simulated diagnostic tool having a probe that may be manipulated to contact one of the probe points, the diagnostic tool being adapted to read the unique identifier code stored by the electronically readable memory when the probe is manipulated to contact the probe point, and to communicate the unique identifier code to a computer simulation of the system or machine.

### BRIEF DESCRIPTION OF THE DRAWINGS

Further features and advantages of the present invention will become apparent from the following detailed description, taken in combination with the appended drawings, in which:

FIG. 1 is a block diagram that schematically illustrates components of a training system in accordance with the invention;

FIGS. 2a,b is a flow chart illustrating principal internal operations of a training system in accordance with the invention;

FIGS. 3a,b are schematic diagrams illustrating two embodiments of training systems in accordance with the invention;

FIG. 4 is a block diagram that schematically illustrates principal components of an embodiment of a simulated diagnostic tool in accordance with the invention; and

FIG. 5 is a flow chart illustrating principal steps in a method of providing a simulation in accordance with the invention.

It will be noted that throughout the appended drawings, like features are identified by like reference numerals.

### DETAILED DESCRIPTION OF THE PREFERRED EMBODIMENT

The invention provides an improved training system and method for operation, diagnostic, maintenance or procedure training for systems or machines. The training system associates unique identifier codes with probe points on a mechanical mock-up of simulated components of the system or machine. The unique identifier codes are used to signal to a system/machine simulation the contact a probe makes with the probe point on the mechanical mock-up, and the system/machine simulation provides the simulated response to the contact of the probe without requiring wired connection between the mechanical mock-up and a host computer that interfaces with the system/machine simulation.

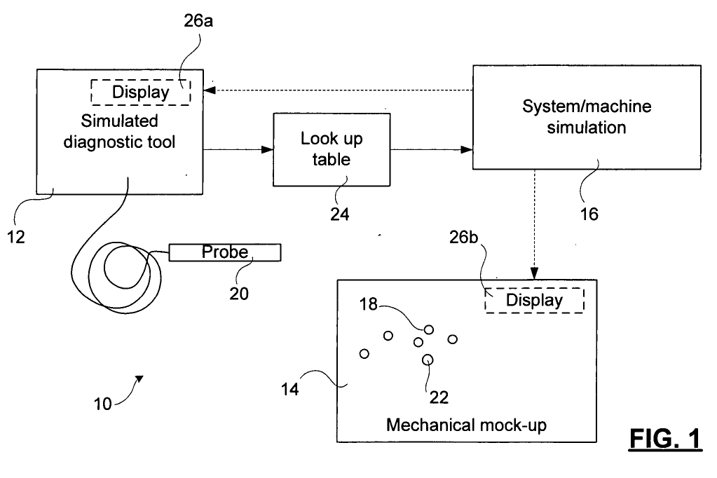

FIG. 1 is a schematic block diagram of a training system in accordance with the invention. The training system 10 includes a simulated diagnostic tool 12 that is used to probe selected points on a mechanical mock-up 14 of at least a part of complex system or machine. The simulated diagnostic tool 12 also exchanges data with a system/machine simulation 16 that simulates a state of the system or machine associated with the mechanical mock-up 14.

The mechanical mock-up 14 includes a plurality of electronically readable memories 18, each of which generates a respective unique identifier code when a probe point, to which the electronically readable memory is connected, is contacted by a probe 20 of the simulated diagnostic tool 12. In operation, when the probe 20 contacts a probe point 22 of the mechanical mock-up 14, (hereinafter referred to as a “probe event”) the unique identifier code is transmitted through the probe point 22 and the probe 20 to the simulated diagnostic tool 12. In the illustrated embodiment, electrical contact between the probe 20 and electronically readable memory 18 is provided by an electrical connection between the probe point 22 and the electronically readable memory 18. The electronically readable memories 18 may be touch memory buttons such as iButtons® commercially available from Dallas Semiconductor Inc. of Dallas, Tex., U.S.A., which is a computer chip encased in a sealed container. Alternatively other cards, tokens, and devices that are adapted to generate a unique identifier can be used. Preferably these devices are small enough that the electronically readable memories 18 and probe points 22 can be easily arranged with minimal wiring and configuration considerations.

The unique identifier code is translated using a look-up table 24 to identify a probe point with which the identifier code is uniquely associated. The system/machine simulation 16 is informed of probe events as they occur. If a probe event affects a state of the system/machine simulation 16, simulation parameters are updated in a manner known in the art.

Most simulated diagnostic tools provide visual feedback to trainees in a realistic way using, for example, a visual display 26a. The mechanical mock-up 14 may also optionally have inputs and/or outputs that are updated by the system/machine simulation 16. When the system/machine simulation 16 updates a display simulation parameter, the parameter is forwarded to any affected display element of the training system 10, to provide visual feedback to the trainee(s).

The system/machine simulation 16 also maintains simulation parameters relating to a state of the simulated diagnostic tool 12, and updates those parameters as required in response to probe events.

Preferably the mechanical mock-up 14 is an exact replica of the part of the system or machine simulated, in order to provide a realistic training experience. In accordance with the illustrated embodiment, this correspondence involves providing probe points 22 on the mechanical mock-up 14 that are of similar configuration, position, and type to those of the simulated system/machine. If, for example, the probe points 22 are conductors connected to a circuit board, or a bundle of conductors, the conductors are connected to a ground via respective electronically readable memories 18.

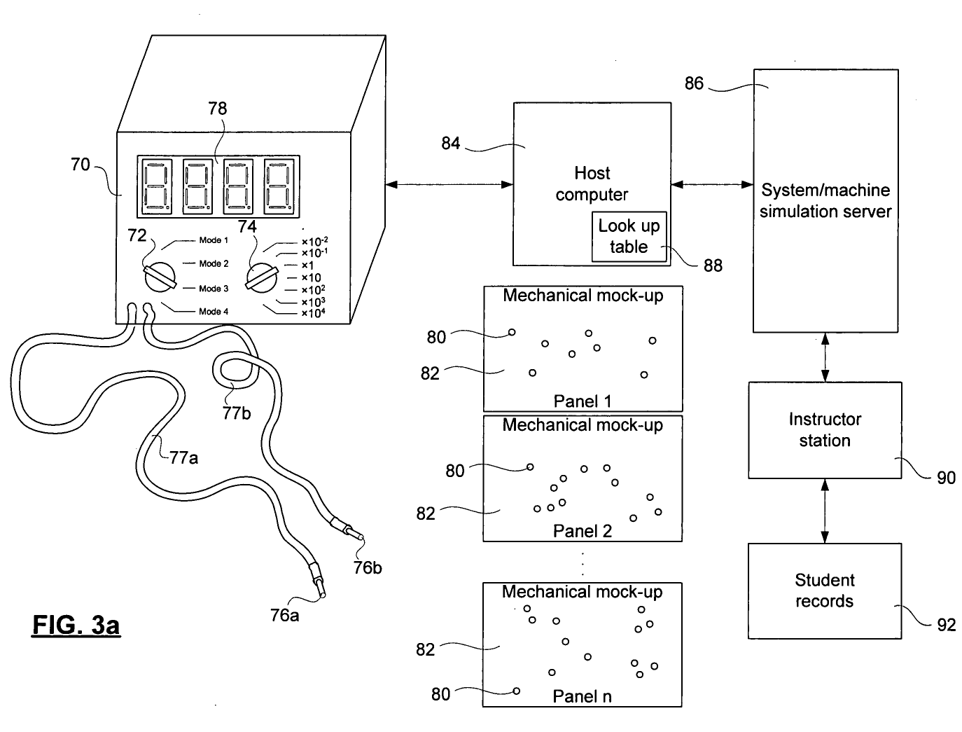

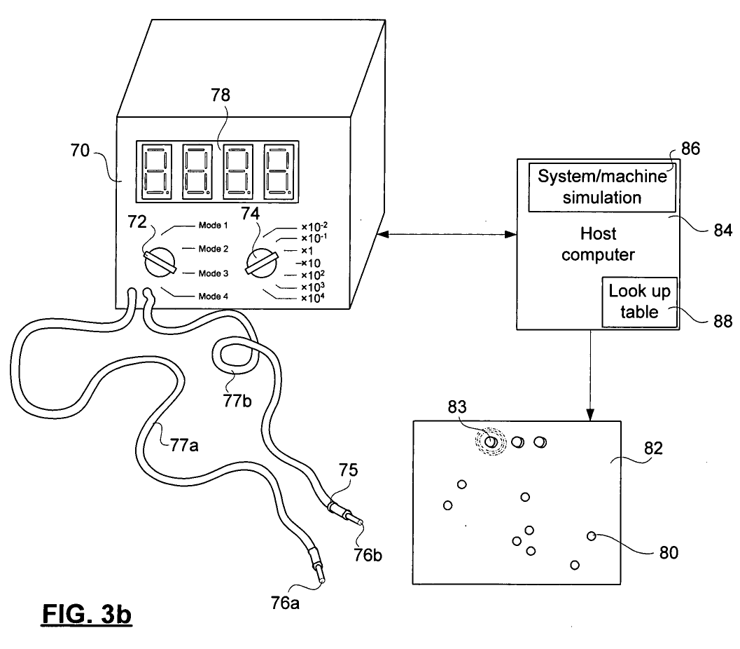

It should further be noted that the training system 10 can be used for group training wherein a team of users with similar or different functions and simulated diagnostic tools 12 can be concurrently trained. In such embodiments probe events indicate to the system/machine simulation 16 which simulated diagnostic tool is associated with each probe event. In such systems care should be taken to ensure that interaction between the simulated diagnostic tool 12 and the mechanical mock-up 14 is realistic (e.g. contact of probes 20 with probe points 22, etc.). Desired results may be achieved by connecting an electronically readable memory 18 to one of the probes 20, as will be described below with reference to FIG. 3b.

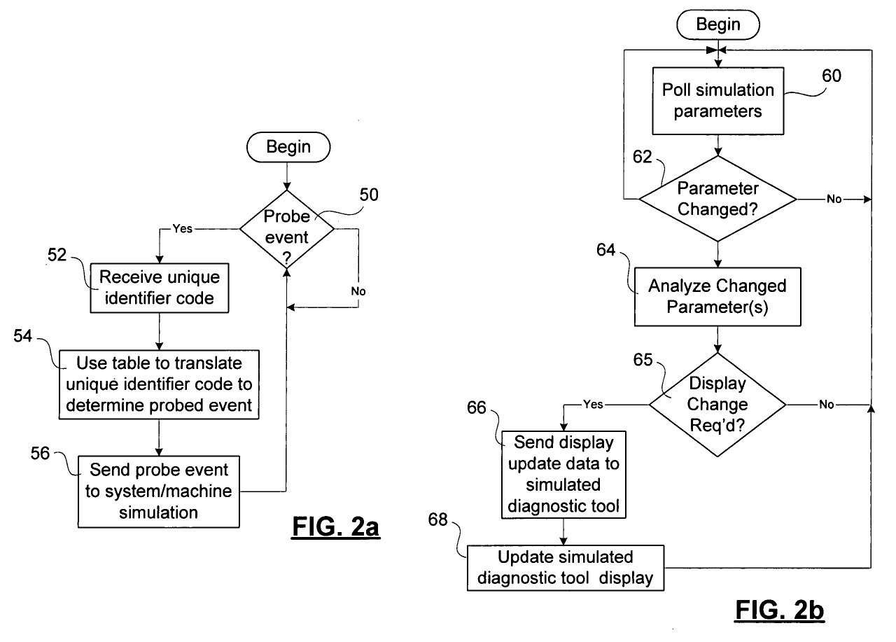

FIG. 2a is a flow chart illustrating principal steps involved in probe event processing by the training system 10 shown in FIG. 1. The simulated diagnostic tool 12 constantly monitors probe inputs for probe events, and, in step 50, it is determined if the probe 20 is in contact with a probe point 22 of the mechanical mock-up 14 by detecting when an electronically readable memory 18 has been read. If a probe event has not occurred, the procedure returns to step 50. Otherwise a unique identifier code is received by the simulated diagnostic tool (step 52). The unique identifier code is translated by the look-up table 24 and a probe event is determined (step 54). The probe event may result from contact with a new probe point 22, or the separation of the probe 20 from a probe point 22 with which it has been in contact. The probe event is sent to the system/machine simulation 16 in step 56.

FIG. 2b schematically illustrates an exemplary procedure for updating a display 26 of the simulated diagnostic tool 12 in response to a change in a state of the system/machine simulation 16. The procedure involves steps of polling simulation parameters to determine if a simulation parameter has changed (step 60). If a simulation parameter change has not occurred (step 62), the process returns to step 60 and the polling is repeated. If a change in a simulation parameter has occurred, the changed parameter is analyzed (step 64). As will be understood by those skilled in the art, not all changes to a simulation parameter need be communicated to the simulated diagnostic tool 12. For example, a change in a simulation parameter retrieved from the system/machine simulation 16 may not be relevant to the simulated diagnostic tool 12 given a currently selected mode, and for this reason may not be retrieved. Furthermore, the values of the parameters may be provided with predetermined precision and a scale of the simulated diagnostic tool 12 may not be sensitive to a change of a given magnitude. Such conditions are preferably detected prior to transmission to the simulated diagnostic tool 12 to avoid unnecessary communication. If it is determined that no display change is required (step 65), the procedure returns to step 60. Otherwise, display update data is sent to the simulated diagnostic tool 12 (step 66). In step 68, the display update data is used to update the display 26, and the procedure returns to step 60.

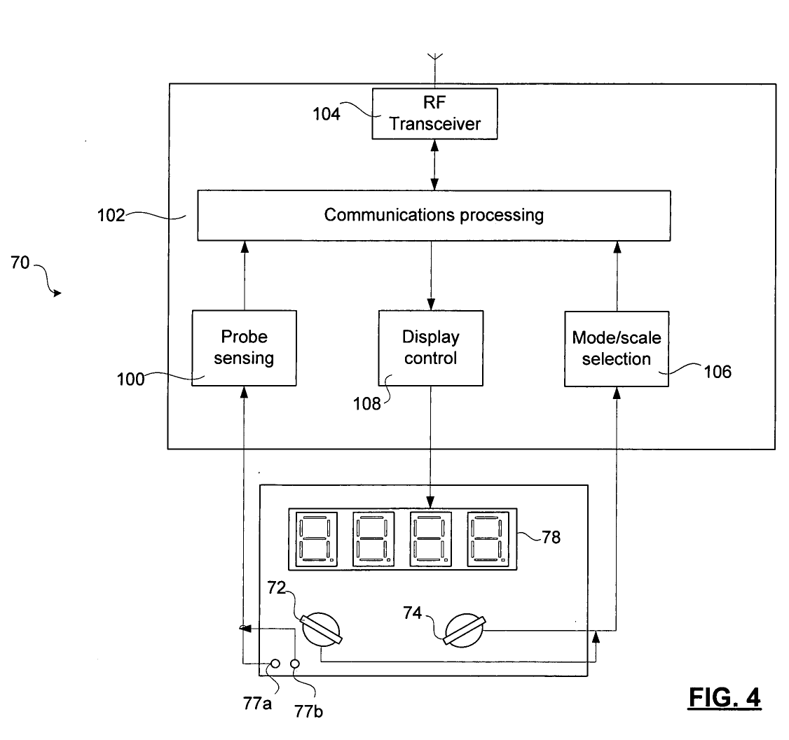

FIG. 3a schematically illustrates an embodiment of the invention used for procedure and/or maintenance training on an electrical system of a machine. The simulated diagnostic tool illustrated is a simulated digital multimeter 70. Digital multimeters (DMMs) are well known in the art and used for measuring electrical properties of circuits. Most DMMs are equipped with mode and scale selector inputs, and positive and negative probes. Accordingly, the simulated digital multimeter 70 (SDMM) is equipped with mode selector 72 and scale selector 74 inputs, and two probes 76a,b connected to the SDMM 70 via respective conductive leads 77a,b. The selectable modes may include resistance, voltage, and current measurements, for example. The SDMM 70 further includes a digital display 78 for displaying a multi-digit value. An internal structure of the SDMM 70 is further described below with reference to FIG. 4.

The mechanical mock-up of the present embodiment comprises a plurality of electrical panels (1 . . . n) 82 each supporting a plurality of probe points that are respectively connected to touch memory buttons (not shown). Each of the electrical panels 82 is preferably constructed in a manner that enhances the realism of the simulated system. In operation, contact of one of the probes 76a,b to one of the probe points 80 supplies an activating current to a touch memory button that is in electrical connection with the probe point 80. When activated, the touch memory button transmits its unique identifier code (a 64 bit digital value in the case of an iButton®), which serves directly or indirectly as a probe event indicator. The touch memory button repeats transmission of the unique identifier code at a predefined frequency so that when the contact between the probe 76a,b and probe point 80 is terminated, the conspicuous absence of the unique identifier code is detected. The detection may be performed at the SDMM 70 or the host computer 84. The unique identifier code is communicated through the corresponding conductive lead 77a/b, to the SDMM 70, where it is relayed to a host computer 84.

The SDMM 70 is therefore communicatively coupled to the host computer 84. In the illustrated embodiment the host computer 84 is collocated with the mechanical mock-up 82 and SDMM 70, but is in networked communication with a remote simulation server 86. The simulation server 86 runs a simulation application for simulating at least relevant functions of the simulated system or machine. The simulation application maintains a plurality of simulation parameters, in a manner that is well known in the art. The host computer 84 subscribes to a plurality of those parameters that are related to SDMM 70. The network load and the sorting of data at the host computer may be controlled by dynamically changing the subscription of values, for example in accordance with the selected mode indicated by the mode selector 72. In this way, only the parameters that are currently relevant to the selected mode are transmitted.

The host computer 84 receives the unique identifier code, and uses a lookup table 90 to translate it to retrieve a probe event corresponding to the probe point 10. The translation defines a probed point event, which occurs at an initial contact of the probe 76 with a probe point 80, or the termination of the contact. When a probe point event is detected, it is transmitted to the simulation server 86 in accordance with an established protocol. The probe point event is interpreted by the simulation server 86, and any affected simulation parameters are updated by the simulation application. If the mode 72 or scale 74 selection inputs are changed, a corresponding selection change update message is transmitted to the simulation server 86, which may update a set of subscribed parameters associated with the host computer. Alternatively, the host computer 64 may be responsible for tracking and updating simulator parameter subscriptions.

The simulation server 86 continuously updates and publishes new values for the parameters it maintains. These parameters relate to every relevant aspect of the simulated system or machine. The simulation server 86 may further apply preprogrammed system faults or other error conditions to the simulation. The host computer 84, regularly polls the simulation server to detect changed values for parameters to which it is subscribed. If a value of a parameter has changed, the host computer 84 determines whether a display change is required, and if so, sends display change data to the display 78 to effect the change.

The simulation server 86 is in communication with an instructor station 88 that permits a collocated or remote instructor to monitor training, to modify a test scenario in progress, to design/set a progression of obstacles for future exercises and tests, to guide the trainee during an exercise, to select the preprogrammed system faults, etc. Records of the pupil's progress and activities may be automatically stored in student records 92. The use of courseware, instructor control, and student records are all well known in the art.

FIG. 3b schematically illustrates an alternative embodiment of the invention wherein the SDMM 70 remains the same, but the mechanical mock-up and training system is different. Because the SDMM 70 is a blind relay of data and provides an interface for receiving display update commands/information the same SDMM 70 can be used in many different training systems.

The only difference between the SDMM 70 shown in FIG. 3a, and that shown in FIG. 3b is that a electronically readable memory (touch memory button) 75 is connected in series with one of the leads 77. This is useful for providing realistic response when the two probes contact each other, either directly or via two points that are electrically connected. It also permits the system to differentiate between the two probes, and allows the instructor to monitor the probing exercise, even when only one probe is being applied. If the two probes 76a,b touch each other, the current from the probe 76a energizes touch memory button 75, resulting in the unique identifier code being transmitted up the lead 77a to the SDMM 70. The fact that the touch memory button 75 may be in series with the probe 76b does not cause collision of the unique identifier codes because of a bus contention mechanism in a 1-wire protocol defined for iButton® communications.

Only one electrical panel 82 is included in the mechanical mock-up illustrated in FIG. 3b, however the electrical panel 82 features three light emitting diodes 83 (LEDs) and accordingly requires a connection between the host computer 84, through which the host computer 84 can control the LEDs 83. It is well known in the art that LEDs, manually toggled switches, alphanumeric and numeric display pads, keypads, analog instruments and other assorted input and output features may be a part of the mechanical mock-up in relation to which the training is required. Accordingly each of these types of inputs and outputs may be represented and provided with a desired type of connection to the host computer 84. In accordance with the embodiment shown in FIG. 3b, the host computer 84 runs the simulation 86 of the system or machine represented by the mechanical mock-up.

FIG. 4 schematically illustrates principal functional components of a preferred embodiment of the SDMM 70 shown in FIGS. 3a,b. As described above, the SDMM 70 serves as a blind relay for the unique identifier codes, and provides the display 78. Therefore the probe contact leads 77a,b are in electrical contact with probe sensing circuitry 100, which receives the unique identifier codes, and forwards them to a communications processor 102 for transmission. In accordance with the illustrated embodiment, communication with the host computer 84 is provided using wireless radiofrequency transmission technology well known in the art, via RF transceiver 104. Both unique identifier codes (received from the probe sensing circuitry 100) and mode and scale setting changes made by the trainee (using the mode 72 and scale 74 selectors) are handled by the communications processing 102 connected to a mode/scale selection circuitry 106. The RF transceiver 104 also receives display change data from the host computer 84, and forwards the data to a display controller 108. The display change data is used to update the value displayed by the display 78 of the SDMM 70, to reflect current simulation parameter values.

The communications processor 102 and RF transceiver 104 are adapted to transmit unique identifier codes retrieved by each of the probes in each transmission interval. The transmission interval for each probe is preferably the reciprocal of the frequency with which the unique identifier codes are transmitted by the touch memory buttons when contact with the probe point 80 is regularly repeating, so that each transmission interval specifies either a unique identifier code of a probe point 80, or a null datum, associated with a probe. The transmission intervals for both probes are the same, but offset in time so that each message issued to the host computer 84 contains only one probe value or a mode/scale setting change.

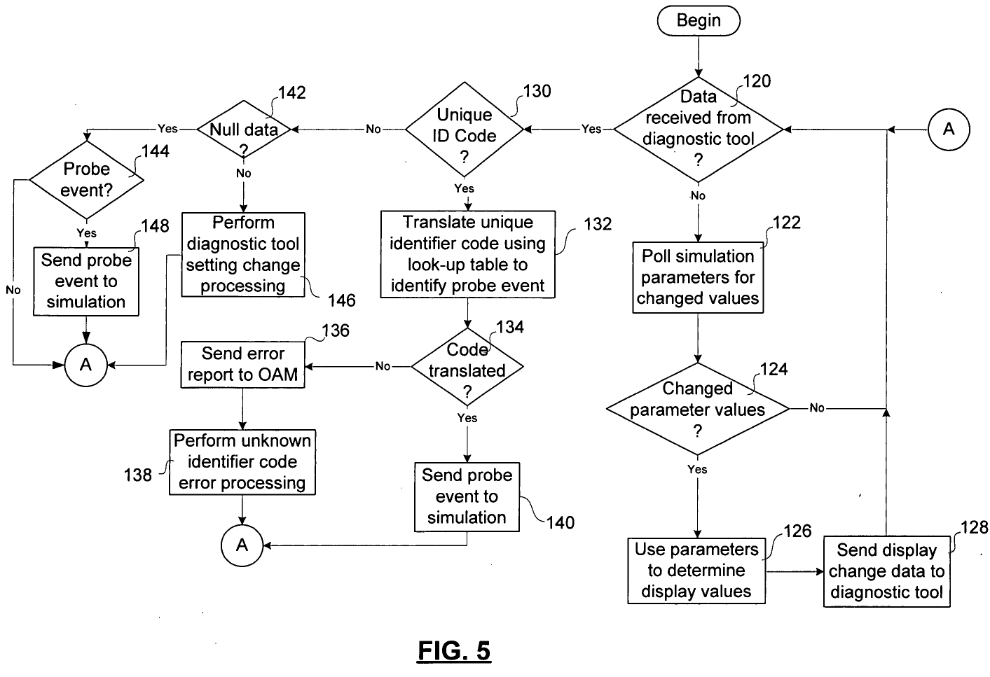

FIG. 5 illustrates principal steps of a procedure applied by the host computer 84 for handling data associated with the training system 10 that is exchanged with a remote simulation server. In step 120 it is determined whether data has been received from a simulated diagnostic tool 12. If no data is received, in step 122, the simulation server is polled to determine if any of the subscribed parameters have changed. While polling is one way of retrieving the data, in accordance with other implementations, other techniques can be used. For example, a change in the subscribed parameters may be automatically queued by the system/machine simulation 16 for transmission to the host computer 84.

In step 124, it is determined whether the subscribed parameter values have changed. If no subscribed parameter values have changed, the procedure returns to step 120. Otherwise the current parameter values are used to determine new display values that reflect the current parameter values (step 126). Corresponding display change data is sent to the simulated diagnostic tool 12 (step 128) so that an appropriate value is displayed at the display 26a. Once the display change data is sent, the procedure returns to step 120.

If, in step 120, it is determined that data is received from the simulated diagnostic tool 12, the data is inspected to determine whether the data contains a unique identifier code read by a respective probe, null data indicating that the probe is not in electrical contact with any of the probe points 22 of the mechanical mock-up 14, or an update relating to a change in a setting of the simulated diagnostic tool 12. In other embodiments the messages may contain more than one data type, however the illustrated implementation uses messages sent from the simulated diagnostic tool 12 to the host computer that convey only one of these three data types.

If it is found (in step 130) that a unique identifier code has been received, the host computer 84 translates the unique identifier code using a look-up table to identify the corresponding probe point 22 (step 132). If the unique identifier code is not recognized (i.e. not associated with a probe point 22 of the mechanical mock-up 14 identified in the look-up table 24) as determined in step 134, an error report is sent to a simulation operations administration and maintenance (OAM) processor (step 136), and unknown unique identifier code error processing is applied (step 138) before the procedure returns to step 120. Otherwise, in step 134, the unique identifier code is associated with a probe point 22 of the mechanical mock-up 14, and the host computer determines what (if any) probe event is to be transmitted to the system/machine simulation 16. Each probe event may correspond to a set of simulation parameters that might have an affect on the state of the simulated system/machine. The sending of the probed event (step 142) may first involve determining if a probed point contact has commenced or terminated, and then only sending an indication of the commencement/termination of contact in a corresponding probed event message. In embodiments where both probes need to contact respective probe points 22 in order to cause a change of the display 26a, step 142 may involve only sending a probed event related to a pair of probed points 22 (that correspond to concurrent contacts made by respective probes) to the system/machine simulation 16 (step 142). As will be understood by those skilled in the art, other implementations of providing probe values to the simulation may also be viable.

If it is determined in step 130 that no unique identifying code was received, it is determined (step 142) whether the data received from the simulated diagnostic tool represents a null datum. The null datum indicates that an identified probe is not in contact with a probe point of the mechanical mock-up 22 (or the other probe in the two-probe simulated diagnostic tool described above). If a null datum is received, the host computer determines whether the null datum constitutes a probe point event (step 144), and if so, sends the probe event to the simulation server (step 146).

If it is determined in step 142 that a null datum is not received, the host computer performs a simulated diagnostic tool setting change procedure (step 144), as a setting change is the only other type of data sent from the simulated diagnostic tool 12 in accordance with the present embodiment. Depending on the implementation of the invention, the setting change procedure may involve modifying (if required) parameter subscription, and update the simulation as to the setting of the simulated diagnostic tool 12. In general the setting changes need to be monitored by the simulation server if the setting has an effect on the simulated probed equipment. Once the setting change processing is completed, the procedure returns to step 120.

The training system in accordance with the invention therefore provides a much simpler construction model for a mechanical mock-up of all or parts of a system/machine to be simulated for training purposes. It also provides a training system that is much more adaptable to change because all interconnections between probe points are logical connections controlled by the simulation software and reconfiguration of an underlying structure therefore requires no reconfiguration of the mechanical-mockup itself. Training systems are therefore much more rapidly constructed and deployed. They are also much more easily maintained and adapted to reflect changes in the systems or machines that they are designed to simulate.

The embodiments of the invention have been described above with reference to specific embodiments of electronically readable memories (the iButton®) and specific simulation models. As will be understood by persons skilled in the art, other electronically readable memories that are compact, self-contained, and adapted to yield a unique identifier code when stimulated by an electric current may be used in a mechanical mock-up in accordance with the invention.. As will also be understood by those skilled in the art, there are many models that may be used for simulating a system or machine, and models other than the one used to describe embodiments of the invention could be adapted for use in the training system in accordance with the invention.

The embodiments of the invention described above are therefore intended to be exemplary only. The scope of the invention is intended to be limited solely by the scope of the appended claims.

1. A mechanical mock-up used for training, the mock-up having a plurality of discrete probe points that may be respectively contacted by a probe of a diagnostic tool used in the training, the mechanical mock-up comprising:
a respective electronically readable memory in electrical connection with each probe point, the electronically readable memory storing a unique identifier code that can be read by the diagnostic tool when the probe contacts the probe point.

2. The mechanical mock-up as claimed in claim 1 wherein each electronically readable memory comprises a computer chip encased in a sealed container.

3. The mechanical mock-up as claimed in claim 1 wherein the mechanical mock-up simulates electrical control panels of a machine.

4. A system for providing operation, diagnostic, procedure or maintenance training, comprising:
a mechanical mock-up of at least a part of a system on which the training is required, the mechanical mock-up having a plurality of probe points which are respectively connected to electronically readable memories that respectively store a unique identifier code;
a host computer comprising means for communicating with a system/machine simulation, and means for associating each unique identifier code with a corresponding probe event, passing a probe point event to the system/machine simulation, and determining a response of the system/machine simulation to the probe event; and
simulated diagnostic equipment having at least one probe that can be maneuvered to contact any one of the probe points, means for reading the unique identifier code when one of the probe points is contacted by the probe, means for communicating with the host computer in order to pass each unique identifier code to the host computer and to receive feedback from the host computer, and means for processing the feedback to determine a display value to be displayed.

5. The system as claimed in claim 1 wherein each of the electronically readable memories respectively comprise a microelectronic circuit that is activated to output the unique identifier code when the probe contacts a probe point to which the microelectronic circuit is connected.

6. The system as claimed in claim 5 wherein the probe activates the microelectronic circuit when it contacts the probe point by supplying an electrical current through the connection to the microelectronic circuit.

7. The system as claimed in claim 6 wherein the electronically readable memory comprises a touch memory button.

8. The system as claimed in claim 1 wherein the simulated diagnostic tool comprises an electronic multimeter having two probes.

9. The system as claimed in claim 8 wherein the simulated diagnostic tool comprises a simulated digital multimeter, with a mode selector input, and a communications processor for communicating with the host computer.

10. The system as claimed in claim 9 wherein the host computer is adapted to use the mode selection input to determine a set of simulation parameters maintained by the simulation that are to be associated with the display value.

11. The system as claimed in claim 10 further comprising an instructor station that may be used to control the simulation to simulate system faults.

12. The system as claimed in claim 11 wherein the instructor station further permits an instructor to monitor a training exercise, guide a trainee through a training exercise, create a simulation program, and to select preprogrammed system faults.

13. The system as claimed in claim 12 further comprising an electronic memory in communications with the host computer for storing student responses to training exercises.

14. The system as claimed in claim 12 wherein the host computer further comprises a look-up table for associating the unique identifier code with a probe point of the simulated probed equipment to identify a probe point event, and a procedure for communicating the probe point event to the simulation server.

15. A simulated diagnostic tool for operation, diagnostic, procedure or training for a system or machine using a simulation and a mechanical mock-up of at least a part of the system or machine, the simulated diagnostic tool comprising:
a probe for supplying an electrical current to an electronically readable memory that is in electrical connection with an electrically conductive probe point of the mechanical mock-up when the probe contacts the probe point;
a communications processor communicatively coupled to the simulation, for relaying to the simulation a unique identifier code retrieved by the probe from the electronically readable memory, and for receiving display change data from the simulation; and
a display for displaying a value determined using the display change data.

16. The simulated diagnostic tool as claimed in claim 15 wherein the simulated diagnostic tool is a multimeter that further comprises a user input for selecting a mode, and the mode selection is used to determine the value displayed.

17. The simulated diagnostic tool as claimed in claim 16 wherein the simulated diagnostic tool comprises two probes, and the communication processor relays to the simulation the unique identifier codes retrieved by each of the two probes.

18. The simulated diagnostic tool as claimed in claim 17 wherein the simulated diagnostic tool further comprises an electronically readable memory electrically coupled to at least one of the two probes to permit the simulation to detect when the two probes are in contact with each other.

19. An article comprising:
a computer readable modulated electrical signal emitted from an electronically readable memory connected to a mechanical mock-up of a system or a machine upon electrical contact with a probe of a simulated diagnostic tool; and
a unique identifier code embedded in the signal for permitting a training system to determine a probe event that indicates electrical contact between the probe and a probe point on the mechanical mock-up.

20. A method of constructing a training system for at least one of diagnostic, procedure and maintenance training for a system or a machine, comprising:
constructing a mechanical mock-up of at least a part of the system or the machine, the mechanical mock-up comprising probe points in respective electrical connection with corresponding electronically readable memories that store unique identifier codes; and
constructing a simulated diagnostic tool having a probe that may be manipulated to contact one of the probe points, the diagnostic tool being adapted to read the unique identifier code stored by the electronically readable memory when the probe is manipulated to contact the probe point, and to use the unique identifier code to send a probe event to a computer simulation of the system or machine.
